(19) United States
(12) Patent Application Publication
(10) Pub. No.: US 2026/0304128 A1
(43) Pub. Date: Oct. 1, 2026

(54) ATTACKS AND DEFENSE IN FEDERATED REINFORCEMENT LEARNING-BASED WIRELESS NETWORKS

(71) Applicant: Telefonaktiebolaget LM Ericsson (publ), Stockholm (SE)

(72) Inventors: Han ZHANG, Ottawa (CA); Hao ZHOU, Ottawa (CA); Melike EROL-KANTARCI, Ottawa (CA); Medhat ELSAYED, Nepean (CA); Majid BAVAND, Ottawa (CA); Raimundas GAIGALAS, Hässelby (SE); Yigit OZCAN, Gloucester (CA)

(21) Appl. No.: 19/480,638

(22) PCT Filed: May 3, 2024
(86) PCT No.: PCT/IB2024/054337

§ 371 Date: Oct. 31, 2025

Related U.S. Application Data
(60) Provisional application No. 63/500,329, filed on May 5, 2023.

(51) Int. Cl. H04W 12/122

(52) U.S. Cl. CPC H04W 12/122

(57) ABSTRACT

A method, system and apparatus are disclosed. According to some embodiments, a global node configured to communicate with a plurality of local nodes is provided. Each of the plurality of local nodes comprises a local model. The global node is configured to receive the local model parameters from each of the plurality of local nodes, determine a plurality of Krum distances for the plurality of local models, sort the plurality of local models based on the plurality of Krum distances, calculate a plurality of numerical gaps for the plurality of Krum distances, determine whether to tag at least one of the plurality of local models as a malicious participant based on the plurality of numerical gaps, and aggregate a global model to generate updated global model parameters, the aggregation of the global model is based on the determination.

### FIELD

The present disclosure relates to wireless communications, and in particular, to attacks and designed defense models in FRL-based scenarios such as, for example, cell sleep control scenario.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Further, Federated learning (FL) is particularly useful for wireless networks (e.g., 5G, 6G, etc.) due to its distributed and privacy-preserving features. However, as a distributed system, FL can be vulnerable to malicious attacks. Compared with conventional centralized machine learning (ML) techniques, distributed participants in FL are easier to be attacked and manipulated, and the parameter sharing and updating between local and global servers may expose the FL to a new set of risks. These attacks may lower the effectiveness of ML models and affect user experience. As a result, it is crucial to investigate security problems in FL.

There are different kinds of attacks on FL algorithms, for example, data poisoning attacks, backdoor attacks, and jamming attacks. A common method of defending against attacks in FL is to perform secure aggregation, identifying malicious participants during the global model aggregation.

There have been some existing studies on designing attacks and defense for FL algorithms, but only a few of them are deployed in wireless networks. Among these works, most research focuses on supervised learning and cannot apply to federated reinforcement learning (FRL) models. Also, some of them are tested with ready-to-use data sets and have some limitations if applied to realistic application scenarios. So, there is a need to study possible attacks and defenses in FRL with realistic application scenarios.

### SUMMARY

Some embodiments advantageously provide methods, systems, and apparatuses for attacks and designed defense models in FRL-based scenarios such as, for example, cell sleep control scenario.

In one or more embodiments, attacks and designed defense models were applied in a FRL-based cell sleep control scenario. A heterogeneous cellular network consisting of one macro base station (MBS) and several small base stations (SBSs) is considered in one or more embodiments. The SBS can turn ON or trigger or implement different sleeping modes to save energy costs.

1. In one or more embodiments, two attacks, Byzantine data poisoning attacks and backdoor attacks, were applied to the wireless networks. Although these two attacks have been studied in some existing works, they have been mostly applied to supervised learning models trained with ready-to-use data sets while the present disclosure applies these kinds of attacks to FRL. Also, in the process of designing the attacks, one or more embodiments combine the cell sleep control scenario to give attacks practical meaning related to wireless network control behaviors and metrics.

2. In one or more embodiments, a new defense algorithm called refined-Krum is provided to defend against malicious users in FRL. By calculating the gap between the similarity of local models, the algorithm described in one or more embodiments can identify the malicious participants without knowing the number of malicious participants.

According to one aspect of the present disclosure, a method implemented by a global node that is configured to communicate with a plurality of local nodes is provided. Each of the plurality of local nodes comprises a local model of a plurality of local models where the local model of the plurality of local models is associated with a plurality of local model parameters. The plurality of local model parameters are received from each of the plurality of local nodes. A plurality of Krum distances are determined for the plurality of local models where each of the plurality of local models is associated with a respective one of the plurality of Krum distances. The plurality of local models are sorted based on the plurality of Krum distances. A plurality of numerical gaps are calculated for the plurality of Krum distances where each one of the plurality of numerical gaps corresponds to a numerical gap between two Krum distances of two adjacent local models of the sorted plurality of local models. A determination is performed as to whether to tag at least one of the plurality of local models as a malicious participant based on the plurality of numerical gaps. A global model is aggregated to generate updated global model parameters where the aggregation of the global model is based on the determination.

According to one or more embodiments of this aspect, at least one of the plurality of local models that has been determined to be a malicious participant is excluded from the aggregating.

According to one or more embodiments of this aspect, the aggregating of the global model comprises aggregating a subset of the plurality of local models that are determined to be a non-malicious participant.

According to one or more embodiments of this aspect, the updated global model parameters are indicated to the plurality of local models for training.

According to one or more embodiments of this aspect, a local model tagged as a malicious participant is configured to reduce an accuracy of the global model if aggregated into the global model.

According to one or more embodiments of this aspect, an average numerical gap of the plurality of numerical gaps is determined, if a maximum gap of the plurality of numerical gaps is less than a first threshold, only a local model of the plurality of local models with a smallest Krum distance is tagged as a non-malicious participant. The first threshold corresponds to a multiple of the average numerical gap. The aggregating of the global model is based on the local model tagged as the non-malicious participant.

According to one or more embodiments of this aspect, an average numerical gap of the plurality of numerical gaps is determined. If a maximum gap of the plurality of numerical gaps is greater than a first threshold: determining a second threshold to identify a malicious participant, for each local model of the plurality of local models having a Krum distance less than the second threshold, tagging the local model as a non-malicious participant. The first threshold corresponds to a multiple of the average numerical gap. The aggregating of the global model is based on each local model that is tagged as a non-malicious participant.

According to one or more embodiments of this aspect, the aggregating of the global model is based on at least one local model of the plurality of local models that is not tagged as a malicious participant.

According to one or more embodiments of this aspect, the global model is used in a federated learning process.

According to one or more embodiments of this aspect, the global node is a macro network node and the plurality of local nodes are a plurality of micro network nodes.

According to another aspect of the present disclosure, a global node configured to communicate with a plurality of local nodes is provided. Each of the plurality of local nodes comprises a local model of a plurality of local models where the local model of the plurality of local models is associated with a plurality of local model parameters. The global node is configured to: receive the plurality of local model parameters from each of the plurality of local nodes, determine a plurality of Krum distances for the plurality of local models where each of the plurality of local models is associated with a respective one of the plurality of Krum distances, sort the plurality of local models based on the plurality of Krum distances, calculate a plurality of numerical gaps for the plurality of

Krum distances where each one of the plurality of numerical gaps corresponds to a numerical gap between two Krum distances of two adjacent local models of the sorted plurality of local models, determine whether to tag at least one of the plurality of local models as a malicious participant based on the plurality of numerical gaps, and aggregate a global model to generate updated global model parameters where the aggregation of the global model is based on the determination.

According to one or more embodiments of this aspect, the global node is further configured to exclude, from the aggregation, at least one of the plurality of local models that has been determined to be a malicious participant.

According to one or more embodiments of this aspect, the aggregation of the global model comprises aggregating a subset of the plurality of local models that are determined to be a non-malicious participant.

According to one or more embodiments of this aspect, the global node is further configured to indicate the updated global model parameters to the plurality of local models for training.

According to one or more embodiments of this aspect, a local model tagged as a malicious participant is configured to reduce an accuracy of the global model if aggregated into the global model.

According to one or more embodiments of this aspect, the global node is further configured to: determine an average numerical gap of the plurality of numerical gaps, and if a maximum gap of the plurality of numerical gaps is less than a first threshold, tag only a local model of the plurality of local models with a smallest Krum distance as a non-malicious participant. The first threshold corresponds to a multiple of the average numerical gap. The aggregation of the global model is based on the local model tagged as the non-malicious participant.

According to one or more embodiments of this aspect, the global node is further configured to: determine an average numerical gap of the plurality of numerical gaps, if a maximum gap of the plurality of numerical gaps is greater than a first threshold: determine a second threshold to identify a malicious participant, and for each local model of the plurality of local models having a Krum distance less than the second threshold, tag the local model as a non-malicious participant. The first threshold corresponds to a multiple of the average numerical gap. The aggregation of the global model is based on each local model that is tagged as a non-malicious participant.

According to one or more embodiments of this aspect, the aggregation of the global model is based on at least one local model of the plurality of local models that is not tagged as a malicious participant.

According to one or more embodiments of this aspect, the global model is used in a federated learning process.

According to one or more embodiments of this aspect, the global node is a macro network node and the plurality of local nodes are a plurality of micro network nodes.

According to another aspect of the present disclosure, a method implemented by a local node that is configured to communicate with a global node is provided. A first local model is trained where the first local model comprises local model parameters. The local model parameters are communicated to the global node. Updated global model parameters associated with a global model are received where the updated global model parameters are based on: a plurality of Krum distances for a plurality of local models including the first local model where each of the plurality of local models being associated with a respective one of the plurality of Krum distances, a plurality of numerical gaps for the plurality of Krum distances where each one of the plurality of numerical gaps corresponds to a numerical gap between two Krum distances of two adjacent local models of the plurality of local models that have been sorted according to the plurality of Krum distances, and whether any of the plurality of local models is a malicious participant based on the plurality of numerical gaps. An aggregation of a global model is based on at least one of the plurality of local models that has been tagged as a non-malicious participant. The local model is updated using the updated global model parameters.

According to one or more embodiments of this aspect, a malicious participant is configured to reduce an accuracy of the global model if aggregated into the global model.

According to one or more embodiments of this aspect, the updating of the local model using the updated global model parameters as part of a federated learning process.

According to one or more embodiments of this aspect, the local node is a micro network node and the global node is a macro network node.

According to another aspect of the present disclosure, a local node configured to communicate with a global node is provided. The local node is configured to: train a first local model, the first local model comprising local model parameters, communicate the local model parameters to the global node, receive updated global model parameters associated with a global model where the updated global model parameters are based on: a plurality of Krum distances for a plurality of local models including the first local model where each of the plurality of local models is associated with a respective one of the plurality of Krum distances, a plurality of numerical gaps for the plurality of Krum distances where each one of the plurality of numerical gaps corresponds to a numerical gap between two Krum distances of two adjacent local models of the plurality of local models that have been sorted according to the plurality of Krum distances, and whether any of the plurality of local models is a malicious participant based on the plurality of numerical gaps. An aggregation of a global model is based on at least one of the plurality of local models that has been tagged as a non-malicious participant. The local model is updated using the updated global model parameters.

According to one or more embodiments of this aspect, a malicious participant is configured to reduce an accuracy of the global model if aggregated into the global model.

According to one or more embodiments of this aspect, the updating of the local model using the updated global model parameters as part of a federated learning process.

According to one or more embodiments of this aspect, the local node is a micro network node and the global node is a macro network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example system according to the principles of the present disclosure;

FIG. 2 is a schematic diagram of an example network architecture illustrating a communication system connected via an intermediate network to a host computer according to the principles in the present disclosure;

FIG. 3 is a block diagram of a host computer communicating via a global node and/or local node with a wireless device over an at least partially wireless connection according to some embodiments of the present disclosure;

FIG. 4 is a flowchart illustrating example methods implemented in a communication system including a host computer, a global node, local node and a wireless device for executing a client application at a wireless device according to some embodiments of the present disclosure;

FIG. 5 is a flowchart illustrating example methods implemented in a communication system including a host computer, a global node and a wireless device for receiving user data at a wireless device according to some embodiments of the present disclosure;

FIG. 6 is a flowchart illustrating example methods implemented in a communication system including a host computer, a global node and a wireless device for receiving user data from the wireless device at a host computer according to some embodiments of the present disclosure;

FIG. 7 is a flowchart illustrating example methods implemented in a communication system including a host computer, a global node and a wireless device for receiving user data at a host computer according to some embodiments of the present disclosure;

FIG. 8 is a flowchart of an example process in a global node according to some embodiments of the present disclosure;

FIG. 9 is a flowchart of another example process in a global node according to some embodiments of the present disclosure;

FIG. 10 is a flowchart of an example process in a local node according to some embodiments of the present disclosure;

FIG. 11 is a flowchart of another example process in a local node according to some embodiments of the present disclosure;

FIG. 12 is a diagram of a structure of FRL-based cell sleep control according to some embodiments of the present disclosure;

FIG. 13 is a diagram of attack and defense models according to some embodiments of the present disclosure;

FIG. 14 is a diagram of a flow chart of a process implemented by global node according to some embodiments of the present disclosure; and

FIG. 15 is a diagram of an example cloud implementation according to some embodiments of the present disclosure.

### DETAILED DESCRIPTION

As discussed above, there is a need to study possible attacks and defenses in FRL with realistic application scenarios.

Further, as the traffic load grows, increasing network energy efficiency (EE) and saving energy costs become a goal for wireless networks. Performing sleep control to local nodes to reduce energy consumption is a feasible way to improve EE and make networks sustainable. There are some proposals to study cell sleep control for energy saving in wireless communications. However, these works are accomplished in fully secure environments and fail to consider attacks and defense.

Cell sleep control has high requirements for system security since attacks may cause different levels of system performance degradation. For example, attacks may waste system energy by making network nodes never sleep or produce low throughput by keeping local nodes in sleep mode, resulting in a low system EE. So, there is a need to study the security problem in cell sleep control.

One or more embodiments described herein solve at least one problem with existing systems by providing attacks and designed defense models in a FRL-based cell sleep control scenario.

Before describing in detail example embodiments, it is noted that the embodiments reside primarily in combinations of apparatus components and processing steps related to attacks and designed defense models in a FRL-based scenarios such as, for example, cell sleep control scenario. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “global node” and “local node” are used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), nodes in a cloud network, servers, etc. The global node and/or local node may also comprise test equipment. The term “radio node” may be used herein may be used to also denote a wireless device (WD) such as a wireless device (WD) or a radio network node. In some embodiments, a local node may be a wireless device or any entity configured to operate a local model as described herein.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smartphone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments, the generic term may be “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure. Further, one or more embodiments may be implemented in a wired and/or wireless network, among other systems where federated learning is implemented according to the teaches described herein.

Note further, that functions described herein as being performed by a global node and local node may be distributed over nodes. In other words, it is contemplated that the functions of the global node and/or local node described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide attacks and designed defense models in a FRL-based cell sleep control scenario.

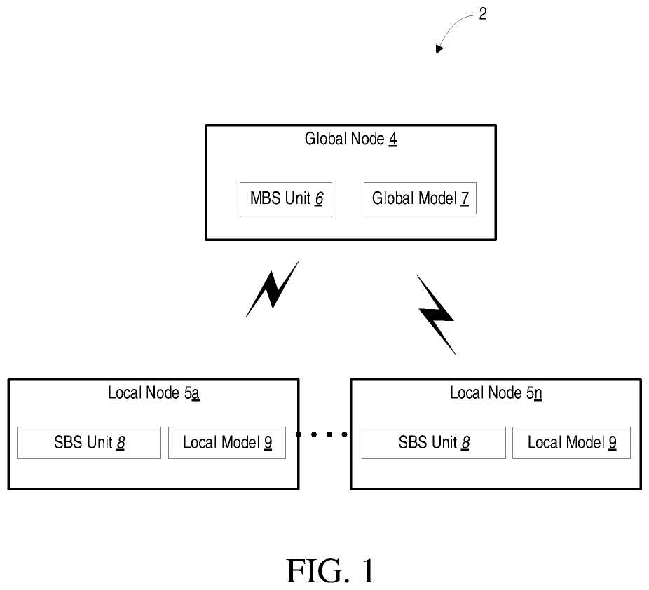

Referring now to the drawing figures, in which like elements are referred to by like reference numerals, there is shown in FIG. 1 a schematic diagram of a communication and/or network system 2. System 2 includes one or more global nodes 4 (collectively referred to as global node 4) and one or more local nodes 5a-5n (collectively referred to as local node 5) that are in communication with the global node 4. In one or more embodiments, the local nodes 5 are not in communication with each other. In one or more embodiments, one or more local nodes 5 are in communication with each other. In one or more embodiments, global node 4 and local nodes 5 are configured for federated learning as described herein.

Global node 4 is configured to include an MBS unit 6 for performing one or more functions as described herein such as with respect to attacks and designed defense models in a FRL-based scenarios such as, for example, cell sleep control scenario. Global node 4 is further configured to store, analyze, update, etc., a global model 7 as described herein. Local node 5 is configured to include an SBS unit 8 for performing one or more functions as described herein such as with respect to attacks and designed defense models in a FRL-based scenarios such as, for example, cell sleep control scenario. Local node 5 is further configured to store, analyze, update, etc., a local model 9 as described herein.

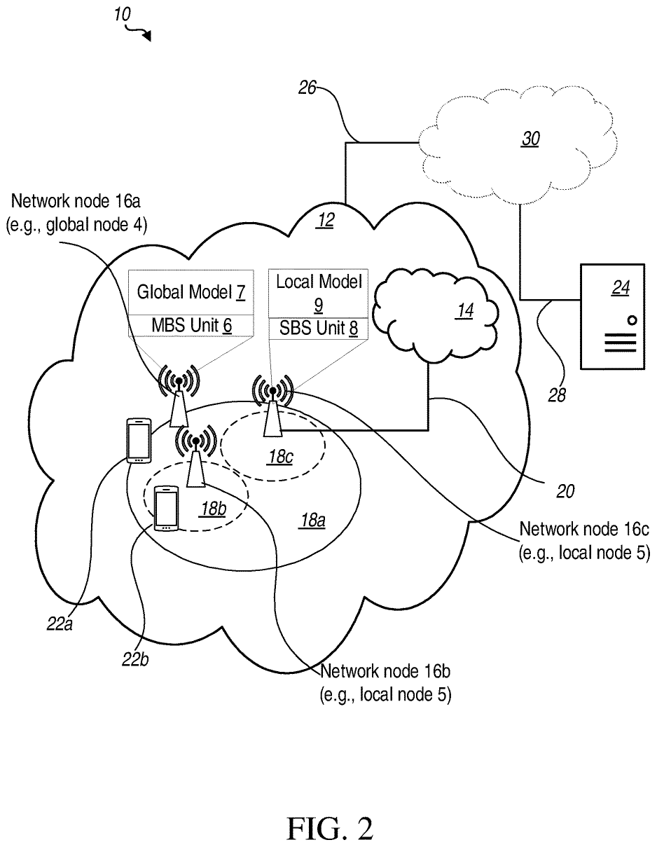

With respect to FIG. 2, a schematic diagram of an example communication system 10 is provided, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). In one or more embodiments, network node 16a is a global node 4 and network nodes 16b and 16c are local nodes 5. Each network node 16a, 16b, 16c is connectable to the core network 14 over a wired or wireless connection 20.

A first wireless device (WD) 22a located in coverage area 18a is configured to wirelessly connect to, or be paged by, the corresponding network node 16a. In this example, the coverage area 18a overlaps with the coverage area of 18b and 18c, although other configurations are possible in view the teachings described herein. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16a (e.g., global node 4), in this example, is configured to include MBS unit 6 which is configured to perform one or more network node 16 functions as described herein such as with respect to, for example, attacks and designed defense models in a FRL-based scenarios such as, for example, cell sleep control scenario. Further, network node 16a is configured to include global model 7 as described herein.

Network node 16b and 16c (e.g., local node 5), in this example, is configured to include SBS unit 8 which is configured to perform one or more network node 16 functions as described herein such as with respect to, for example, attacks and designed defense models in a FRL-based scenarios such as, for example, cell sleep control scenario. Further, network node 16b and 16c are configured to include local model 9, as described herein.

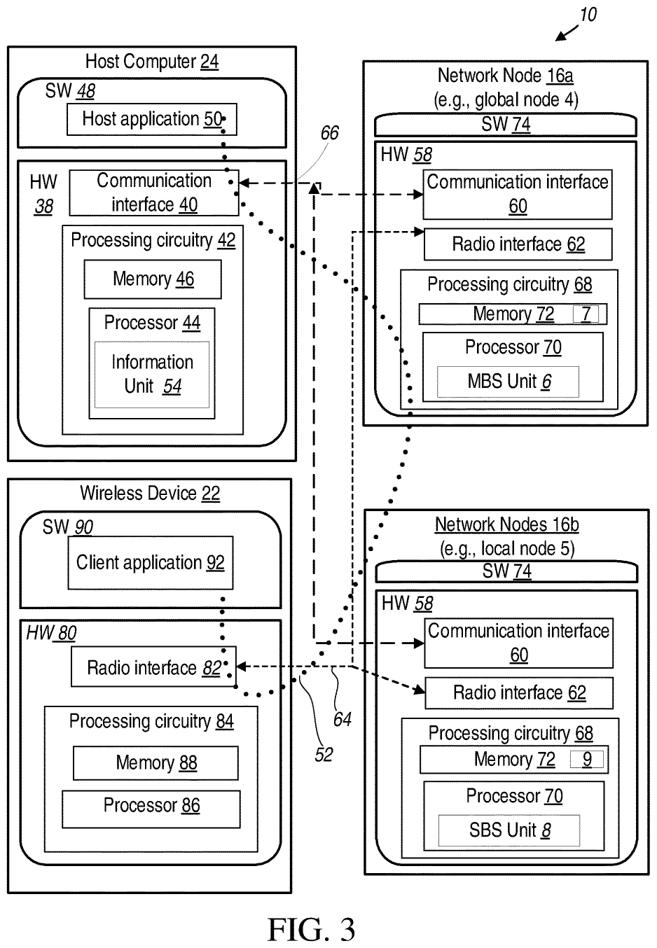

Example implementations, in accordance with an embodiment, of the WD 22, network node 16a, b and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to perform one or more of analyze, store, process, forward, relay, transmit, communicate, etc., information related to attacks and designed defense models in a FRL-based scenarios such as, for example, cell sleep control scenario.

The communication system 10 further includes a network node 16a (e.g., operating as global node 4) provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16a. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16a further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16a further has software 74 stored internally in, for example, memory 72, or stored in external memory (e.g., database, storage array, network storage device, etc.) accessible by the network node 16a via an external connection. The software 74 may be executable by the processing circuitry 68. The processing circuitry 68 may be configured to control any of the methods and/or processes described herein and/or to cause such methods, and/or processes to be performed, e.g., by network node 16a. Processor 70 corresponds to one or more processors 70 for performing network node 16a functions described herein. The memory 72 is configured to store data, programmatic software code, global model 7, and/or other information described herein. In some embodiments, the software 74 may include instructions that, when executed by the processor 70 and/or processing circuitry 68, causes the processor 70 and/or processing circuitry 68 to perform the processes described herein with respect to network node 16a. For example, processing circuitry 68 of the network node 16 may include MBS unit 6 configured to perform one or more network node 16 functions as described herein such as with respect to attacks and designed defense models in a FRL-based scenarios such as, for example, cell sleep control scenario.

The communication system further includes network node 16b (e.g., operating as local node 5) that include hardware 58 and software 74 as described above with respect to network node 16a with the exception that network node 16b includes local model 9 stored in memory 72 and SBS unit 8 that is configured to perform one or more network nodes 16 functions as described herein such as with respect to attacks and designed defense models in a FRL-based scenarios such as, for example, cell sleep control scenario. Other network nodes 16 functioning and/or operating as local nodes 5 are not shown in FIG. 3 but system 10 may include one or more of these network nodes 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry/Circuits) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as MBS unit 6 and SBS unit 8 as being within a respective processor, it is contemplated that these units may be implemented such that a portion of the unit is stored in a corresponding memory within the processing circuitry. In other words, the units may be implemented in hardware or in a combination of hardware and software within the processing circuitry.

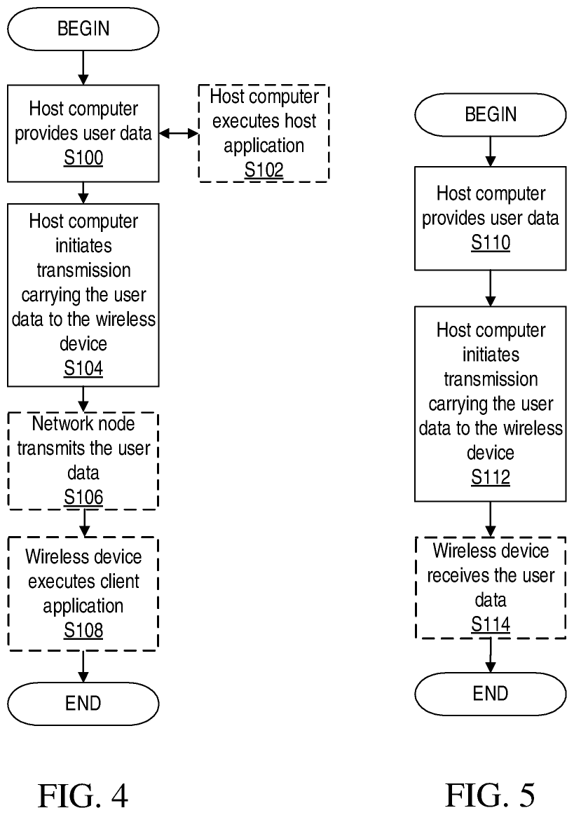

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

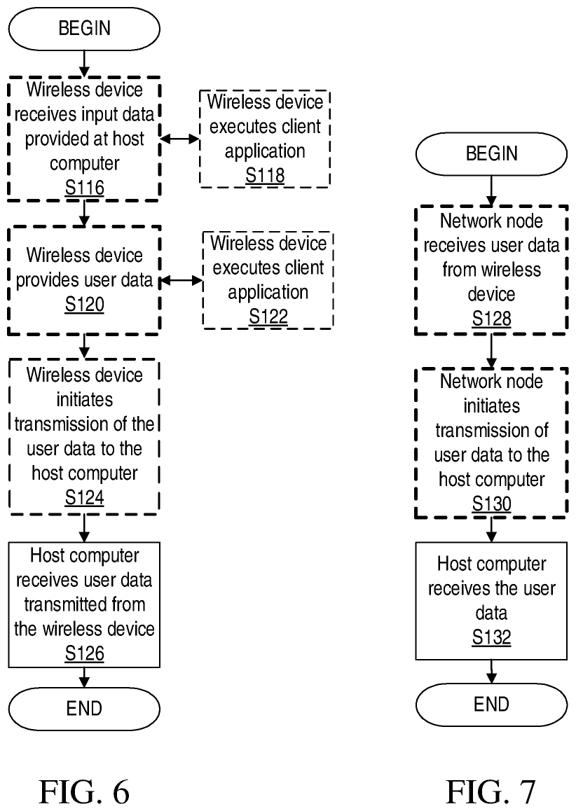

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

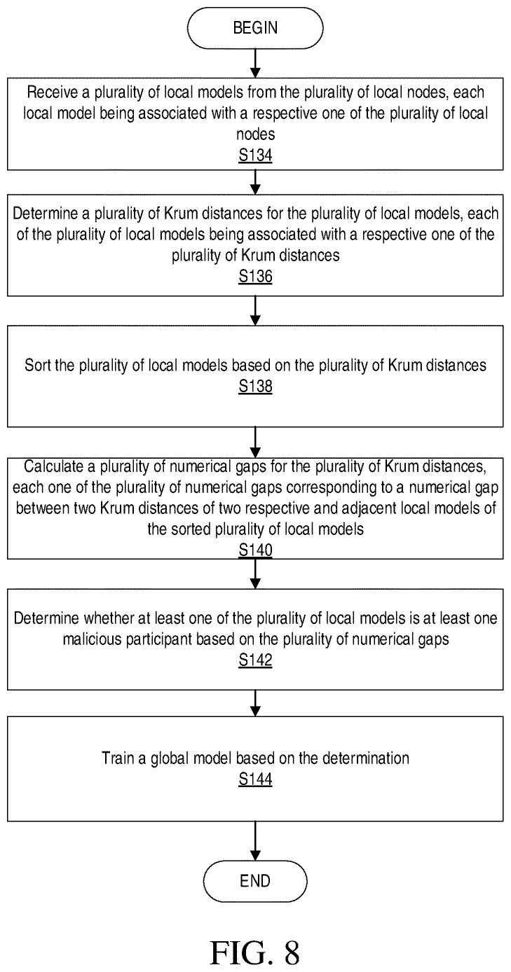

FIG. 8 is a flowchart of an example process in a network node 16 (e.g., operating and/or including functionality of global node 4) according to some embodiments of the present disclosure. One or more blocks described herein may be performed by one or more elements of network node 16 such as by one or more of processing circuitry 68 (including the MBS unit 6), processor 70, radio interface 62 and/or communication interface 60. Network node 16 is configured to receive (Block S134) a plurality of local models (and/or a plurality of local parameters associated with each of the plurality of local models) from the plurality of local nodes 5, where each local model is associated with a respective one of the plurality of local nodes 5, as described herein. Network node 16 is configured to determine (Block S136) a plurality of Krum distances for the plurality of local models 9, where each of the plurality of local models is associated with a respective one of the plurality of Krum distances, as described herein. Network node 16 is configured to sort (Block S138) the plurality of local models based on the plurality of Krum distances, as described herein.

Network node 16 is configured to calculate (Block S140) a plurality of numerical gaps for the plurality of Krum distances, where each one of the plurality of numerical gaps corresponds to a numerical gap between two Krum distances of two respective and adjacent local models of the sorted plurality of local models, as described herein. Network node 16 is configured to determine (Block S142) whether at least one of the plurality of local models is at least one malicious participant based on the plurality of numerical gaps, as described herein. Network node 16 is configured to train (Block S144) a global model based on the determination, as described herein.

According to one or more embodiments, the training of the global model 7 comprises: excluding the at least one of the plurality of local models 9 that has been determined to be a malicious participant from training of the global model 7, and training the global model 7 using a subset of the plurality of local models 9 that have not been determined to be at least one malicious participant.

According to one or more embodiments, the processing circuitry 68 is further configured to indicate at least one updated parameter of the global model 7 to the plurality of local models 9 for training the respective local models 9.

According to one or more embodiments, the at least one of the plurality of local models 9 that has been determined to be at least one malicious participant is associated with at least one of a Byzantine data poisoning attack and backdoor attack.

According to one or more embodiments, the global model 7 is a federated learning model.

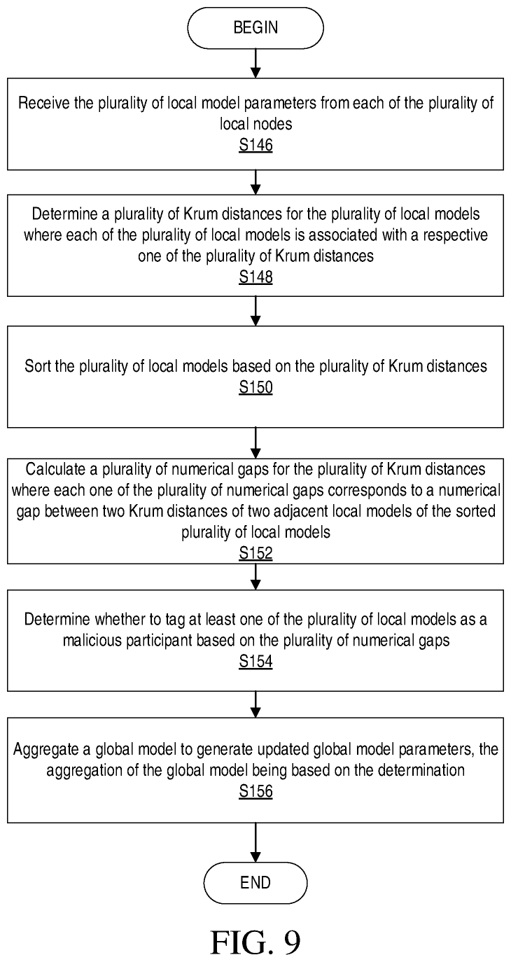

FIG. 9 is a flowchart of an example process in a network node 16 (e.g., operating and/or including functionality of global node 4) according to some embodiments of the present disclosure. One or more blocks described herein may be performed by one or more elements of network node 16 such as by one or more of processing circuitry 68 (including the MBS unit 6), processor 70, radio interface 62 and/or communication interface 60. In one or more embodiments, global node 4 is configured to communicate with a plurality of local nodes 5 where each of the plurality of local nodes 5 comprises a local model 9 of a plurality of local models 9. The local model 9 of the plurality of local models 9 is associated with a plurality of local model parameters.

Global node 4 is configured to receive (Block S146) the plurality of local model parameters from each of the plurality of local nodes 5, as described herein. Global node 4 is configured to determine (Block S148) a plurality of Krum distances for the plurality of local models 9 where each of the plurality of local models 5 are associated with a respective one of the plurality of Krum distances, as described herein. Global node 4 is configured to sort (Block S150) the plurality of local models 9 based on the plurality of Krum distances, as described herein. Global node 4 is configured to calculate (Block S152) a plurality of numerical gaps for the plurality of Krum distances where each one of the plurality of numerical gaps corresponds to a numerical gap between two Krum distances of two adjacent local models 9 of the sorted plurality of local models 9, as described herein.

Global node 4 is configured to determine (Block S154) whether to tag at least one of the plurality of local models 9 as a malicious participant based on the plurality of numerical gaps, as described herein. Global node 4 is configured to aggregate (Block S156) a global model 7 to generate updated global model parameters where the aggregation of the global model 7 is based on the determination, as described herein.

According to one or more embodiments, the global node 4 is further configured to exclude, from the aggregation, at least one of the plurality of local models 9 that has been determined to be a malicious participant.

According to one or more embodiments, the aggregation of the global model 7 comprises aggregating a subset of the plurality of local models 9 that are determined to be a non-malicious participant.

According to one or more embodiments, the global node 4 is further configured to indicate the updated global model parameters to the plurality of local models 9 for training.

According to one or more embodiments, a local model 9 tagged as a malicious participant is configured to reduce an accuracy of the global model 7 if aggregated into the global model 7.

According to one or more embodiments, the global node 4 is further configured to: determine an average numerical gap of the plurality of numerical gaps, and if a maximum gap of the plurality of numerical gaps is less than a first threshold, tag only a local model 9 of the plurality of local models 9 with a smallest Krum distance as a non-malicious participant. The first threshold corresponds to a multiple of the average numerical gap. The aggregation of the global model 7 is based on the local model 9 tagged as the non-malicious participant.

According to one or more embodiments, the global node 4 is further configured to: determine an average numerical gap of the plurality of numerical gaps, and if a maximum gap of the plurality of numerical gaps is greater than a first threshold: determine a second threshold to identify a malicious participant, and for each local model 9 of the plurality of local models 9 having a Krum distance less than the second threshold, tag the local model 9 as a non-malicious participant. The first threshold corresponds to a multiple of the average numerical gap. In one or more embodiments, the first threshold may be fixed multiple of the average numerical gap. The aggregation of the global model 7 is based on each local model 9 that is tagged as a non-malicious participant. In one or more embodiments, the second threshold is the threshold for the Krum distance, and it is decided by the maximum numerical gap, e.g., the distance that makes the maximum numerical gap is set as the threshold.

According to one or more embodiments, the aggregation of the global model 4 is based on at least one local model 9 of the plurality of local models 9 that is not tagged as a malicious participant.

According to one or more embodiments, the global model 4 is used in a federated learning process.

According to one or more embodiments, the global node 4 is a macro network node 16 and the plurality of local nodes 5 are a plurality of micro network nodes 16.

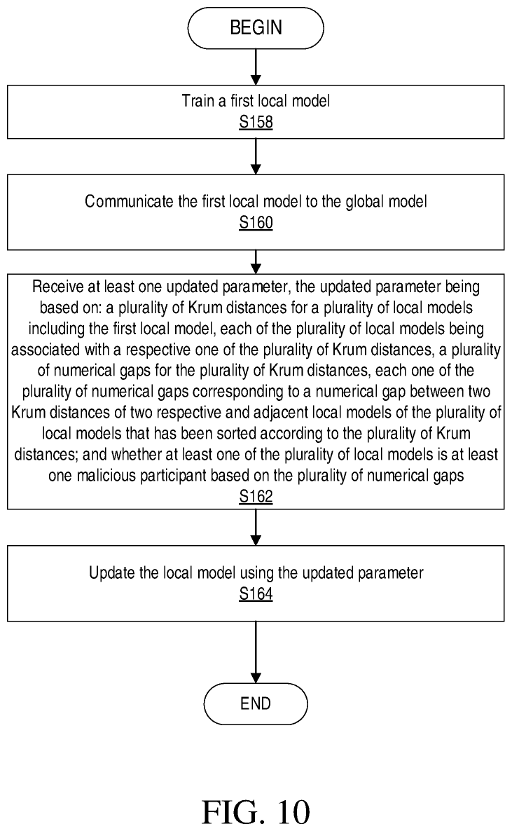

FIG. 10 is a flowchart of an example process in a network node 16 (e.g., operating and/or including functionality of local node 5) according to some embodiments of the present disclosure. One or more blocks described herein may be performed by one or more elements of network node 16 such as by one or more of processing circuitry 68 (including the SBS unit 8), processor 70, radio interface 62 and/or communication interface 60. Network node 16 is configured to train (Block S158) a first local model, as described herein. Network node 16 is configured to communicate (Block S160) the first local model 9 (and/or a plurality of local parameters associated with the first local model 9) to the global model 7, as described herein. Network node 16 is configured to receive (Block S162) at least one updated parameter, where the updated parameter is based on: a plurality of Krum distances for a plurality of local models 9 including the first local model 9, where each of the plurality of local models 9 is associated with a respective one of the plurality of Krum distances, a plurality of numerical gaps for the plurality of Krum distances, where each one of the plurality of numerical gaps corresponds to a numerical gap between two Krum distances of two respective and adjacent local models 9 of the plurality of local models 9 that has been sorted according to the plurality of Krum distances, and whether at least one of the plurality of local models 9 is at least one malicious participant based on the plurality of numerical gaps, as described herein. Network node 16 is configured to update (Block S164) the local model 9 using the updated parameter, as described herein.

According to one or more embodiments, the processing circuitry 68 is further configured to train the updated local model 9.

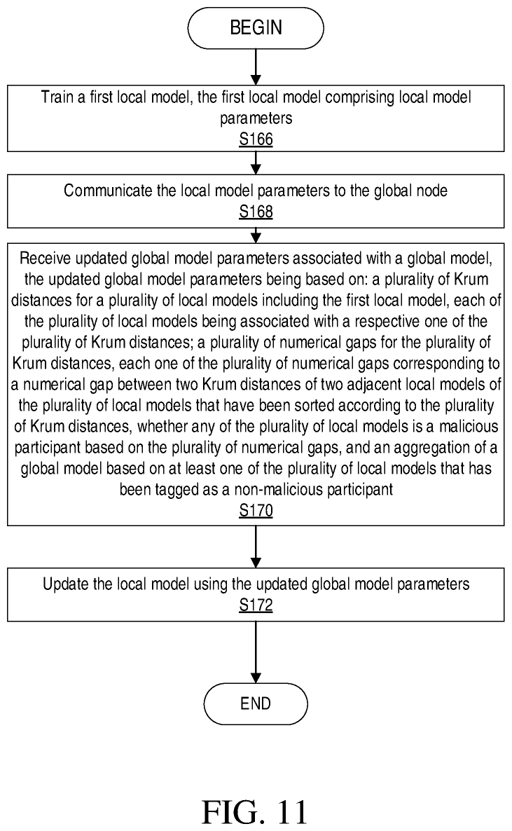

FIG. 11 is a flowchart of an example process in a network node 16 (e.g., operating and/or including functionality of local node 5) according to some embodiments of the present disclosure. One or more blocks described herein may be performed by one or more elements of network node 16 such as by one or more of processing circuitry 68 (including the SBS unit 8), processor 70, radio interface 62 and/or communication interface 60. Local node 5 is configured to train (Block S166) a first local model 7, the first local model 7 comprising local model parameters, as described herein. Local node 5 is configured to communicate (Block S168) the local model parameters to the global node 4, as described herein.

Local node 5 is configured to receive (Block S170) updated global model parameters associated with a global model 4 where the updated global model parameters are based on: a plurality of Krum distances for a plurality of local models 9 including the first local model 9 where each of the plurality of local models 9 is associated with a respective one of the plurality of Krum distances; a plurality of numerical gaps for the plurality of Krum distances where each one of the plurality of numerical gaps correspond to a numerical gap between two Krum distances of two adjacent local models 9 of the plurality of local models 9 that have been sorted according to the plurality of Krum distances; whether any of the plurality of local models 9 is a malicious participant based on the plurality of numerical gaps; and an aggregation of a global model 4 based on at least one of the plurality of local models 9 that has been tagged as a non-malicious participant, as described herein. Local node 5 is configured to update (Block S172) the local model 9 using the updated global model parameters.

According to one or more embodiments, a malicious participant is configured to reduce an accuracy of the global model 4 if aggregated into the global model 7.

According to one or more embodiments, the updating of the local model 9 using the updated global model parameters as part of a federated learning process.

According to one or more embodiments, the local node 5 is a micro network node 16 and the global node 4 is a macro network node 16.

Having described the general process flow of arrangements of the disclosure and having provided examples of hardware and software arrangements for implementing the processes and functions of the disclosure, the sections below provide details and examples of arrangements for attacks and designed defense models in a FRL-based scenarios such as, for example, cell sleep control scenario.

Some embodiments provide attacks and designed defense models in a FRL-based scenarios such as, for example, cell sleep control scenario. One or more network node 16 (e.g., global node 4 or network node 16 including functionality of global node 4) function described below may be performed by one or more of MBS unit 6, processing circuitry 68, processor 70, etc. One or more network node 16 (e.g., global node 4) function described below may be performed by one or more of MBS unit 6, processing circuitry 68, processor 70, etc. One or more network node 16 (e.g., local node 5 or network node 16 including functionality of local node 5) function described below may be performed by one or more of SBS unit 8, processing circuitry 68, processor 70, etc. One or more network node 16 (e.g., global node 4) function described below may be performed by one or more of SBS unit 8, processing circuitry 68, processor 70, etc.

One or more embodiments described herein one or more of provide, configure, design, etc. attack and defense models in FRL-enabled wireless networks. Specifically, a cell sleep control scenario is considered. The description below, in general, first introduces how the FRL-based cell sleep control is designed, and then presents details about the attack and defense models.

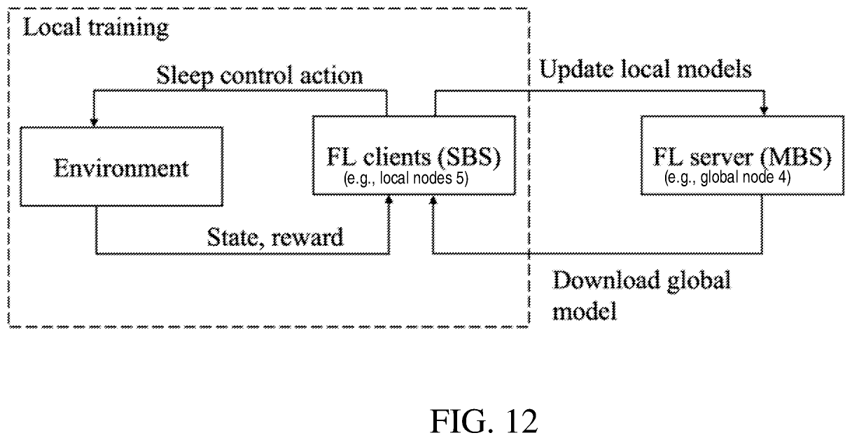

FIG. 12 is a block diagram of the structure of FRL-based cell sleep control. In this structure, one MBS (e.g., global node 4, network node 16a) and several SBSs (e.g., local nodes 5, network nodes 16b, 16c) cooperatively serving multiple distributed wireless devices 22 is considered. The MBS is always active to help ensure coverage and controls signaling and data services. SBSs can be switched to three different sleeping modes to effectively save energy costs, which are active, sleep, and deep sleep. In the active mode,

SBSs fully operate and consume the most energy compared to other SBS modes. In the sleep mode, SBSs temporarily stop transmitting data for the wireless devices 22 but can be quickly woken up (e.g., woken up within a first predetermined amount of time). In the deep sleep mode, SBSs turn to a deeper sleep level that takes longer to wake up (e.g., when compared to the sleep mode above), saving more energy.

One goal of SBS is to select the appropriate sleep mode to achieve high wireless device 22 throughput with less power consumption. Here, the EE of the system as:

$$E E = \frac{{\sum }_{m ∈ M} {b}_{m}}{{\sum }_{n ∈ N} {P}_{n} + {P}_{0}} \qquad ( A )$$

where bₘ denotes the throughput of the m^{th} wireless device 22. Pₙ denotes the power consumption of the nth SBS and P₀ denotes the power consumption of the MBS (e.g., global node 4).

To solve this problem, FRL is used to promote privacy-preserving collaborative training. Each SBS holds a local deep reinforcement learning (DRL) model, which observes states and rewards from the environment and selects actions by choosing an adequate sleeping mode. Specifically, deep-Q networks (DQNs) models are used for each SBS as local models, and the optimal actions are selected by maximizing the long-term expected rewards. The MBS serves as a global server (e.g., global node 4) in FRL, collecting local models 9 from SBSs for model aggregation and distributing the global model 7 as feedback.

The state includes the sleeping mode of the SBS and traffic load of the SBS and the MBS in the past (e.g., past transmission time intervals, past predefined time period(s)), which can be used to estimate the upcoming traffic load. It also includes the current delay and throughput of the SBS, which can be given as:

$${s}_{n} = {〚 \{ δ 〛}_{n} , {L}_{n} , {L}_{0} , {d}_{n} , {b}_{n} \} , ∀ n ϵ N , \qquad ( B )$$

where δₙ denotes the sleep status of the n^{th} SBS, Lₙ and L₀ denote the traffic load of the n^{th} SBS and the MBS. dₙ and bₙ denote the delay and the throughput.

The action can be defined as:

$${a}_{n} = \{ 0 , 1 , 2 \} , ∀ n ϵ N . \qquad ( C )$$

The reward can be given as:

$${R}_{n} = 1 - {ϵ}_{n} - {w}_{1} {d}_{n} - {w}_{2} {P}_{n} , ∀ n ϵ N , \qquad ( D )$$

where ∈ₙ denotes the packet drop rate. w₁ and w₂ are two coefficients that balance different rewards.

In addition to local models 9, FRL is adapted to enable collaborative training and accelerate learning. Firstly, the local models 9 will first perform local training, which can be formulated as:

$${θ}_{n}^{t + 1} = {θ}_{n}^{t} + α [ {r}_{n}^{t} + γ {max}_{a} 〚 Q ( {s}_{n}^{t + 1} , a ; {θ}_{n}^{t} 〛 ) - Q 〚 ( {s}_{n}^{t} , {a}_{n}^{t} ; {θ}_{n}^{t} 〛 ) ] \text{} ∇ Q 〚 ( {s}_{n}^{t} , {a}_{n}^{t} ; {θ}_{n}^{t} 〛 ) , \qquad ( E )$$

where

$${θ}_{n}^{t}$$

denotes the local model parameters of the n^{th} SBS.

$$Q \text{?} ( {s}_{n}^{t} , {a}_{n}^{t} ; {θ}_{n}^{t} \text{?} )$$

denotes the long-term expected reward of the nth SBS choosing the action at under the state

$${s}_{n}^{t} .$$

α denotes the learning rate, and y denotes the discount factor. After local training, the local models 9 are uploaded to the global server (e.g., global node 4) for model aggregation, which can be formulated as:

$${θ}_{G}^{t + 1} = {\sum }_{N}^{n = 1} {w}_{n} {θ}_{n}^{t + 1} \qquad ( F )$$

where

$${θ}_{G}^{t + 1}$$

denote the parameters of the global model 7. wₙ is the weight of the local model 9 of the n^{th} SBS and it is decided by the number of training samples. After the global model aggregation, the global model parameters are sent back to the SBSs and the local models 9 are updated by replacing the local parameters with global parameters.

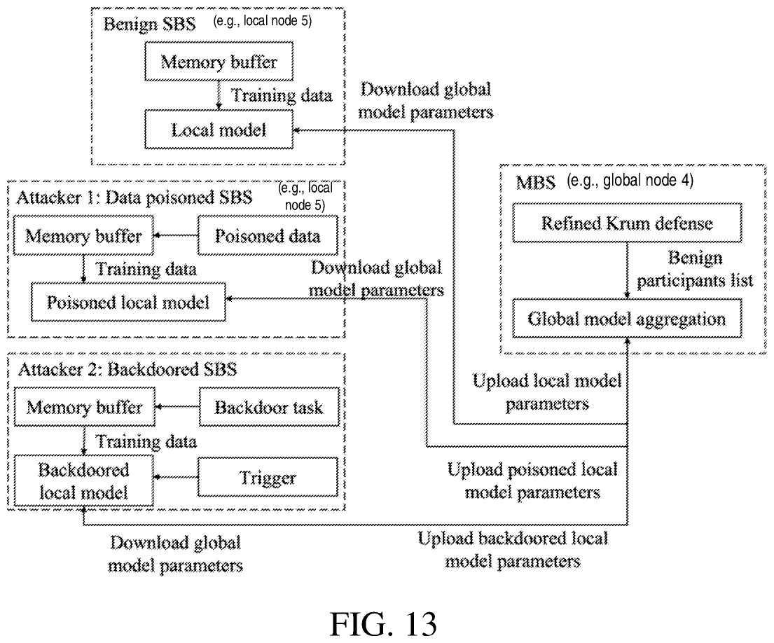

FIG. 13 is a block diagram of an example of the structure of attacks and defense models in FRL-based cell sleep control. To attack the system, it is assumed that one or more SBSs are malicious and can cause system performance degradation by updating malicious local models 9 to the global node 4. For example, updating of the global node 4 (e.g., global model 7) with one or more malicious local models may reduce the accuracy of global mode 7. Two attack models are proposed, which are Byzantine data poisoning attacks and backdoor attacks.

As shown in FIG. 13, Byzantine data poisoning attacks are implemented by injecting poisoned data into the local memory buffer of the malicious participants and making participants train their local model 9 in the wrong direction (e.g., different from training that would results using non-poisoned data). The poisoned local model 9 is trained with a mixture of local experience and poisoned data. In this scenario, the poisoning data was designed and/configured by giving the model 9 a larger reward if the SBS chooses to be active and a smaller reward if the SBS chooses to sleep. After local training, the poisoned local model 9 will be uploaded to the global node 4, and the effect of poisoned data will then be propagated to other local models 9 during the global model aggregation.

Different from regular data poisoning attacks, backdoor attacks use the concept of backdoor tasks by defining a special input data pattern that rarely appears in the original training data. As shown in FIG. 13, the backdoor task-related training data is injected into the memory buffer (e.g., of local node 5) so the backdoor task will be trained during the local training. Every time the backdoor attackers want to attack the system model, they can trigger the backdoor pattern and make the model select abnormal actions.

In the sleep control scenario described herein, the backdoor task is defined as, for example, a SBS with a very high traffic load. The backdoor task and/or the backdoor attack can be triggered by putting a wireless device 22 with an extremely heavy traffic load into the system, and the trigger result is defined as the SBS turning to deep sleep.

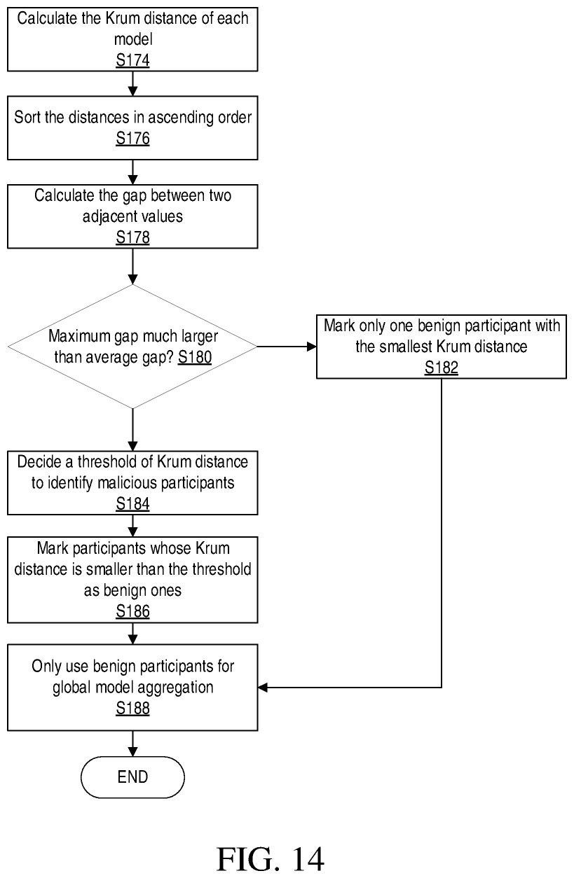

FIG. 14 is a flowchart of an example refined-Krum defense algorithm. Global node 4 is configured to calculate the Krum distance of each model (Block S174). Global node 4 is configured to sort the distances in ascending order (Block S176). Global node 4 is configured to calculate the gap between two adjacent values (Block S178). Global node 4 is configured to determine whether the maximum gap is much larger than the average gap (Block S180). If the maximum gap is not much larger than the average gap, global node 4 is configured to mark only one benign participant with the smallest Krum distance (Block S182). If the maximum gap is much larger than the average gap, global node 4 is configured to decide a threshold of Krum distance to identify malicious participants (Block S184). Global node 4 is configured to mark participants whose Krum distance is smaller than the threshold as benign models (Block S186). If the maximum gap is not much larger than the average gap, global node 4 is configured to only use benign participants for global model aggregation (Block S188). Further details of the process of FIG. 14 are described below.

In the first step, the Krum distance of each model is calculated according to one or more methods such as a Byzantine tolerant gradient descent. The Euclidean distance between parameters of the nth local model 9 and the global model 7 in the last FL iteration is calculated, which can be given as:

$${G\_n}^{∧} ( t + 1 ) = 〚 ‖ θ 〛 {\_n}^{∧} ( t + 1 ) - {θ\_G}^{∧} {t 〚 \vert 〛}_{2} \qquad ( G )$$

Then, the distance between the nth local model and kth local model 9 can be given as:

$${D\_nk}^{∧} ( t + 1 ) = 〚 \vert G 〛 {\_n}^{∧} ( t + 1 ) - {G\_k}^{∧} {( t + 1 ) 〚 \vert 〛}_{2} \qquad ( H )$$

The distance between each local model 9 and all other local models 9 is then added. In this way, the Krum distance for each local model 9 can be obtained, which can be given as:

$${D}_{n}^{t + 1} = {\sum }_{k ϵ N} {D}_{nk}^{t + 1} \qquad ( I )$$

After obtaining the Krum distance of each local model 9, all the models 9 are sorted in ascending order according to their Krum distances. Then, the gap between two adjacent Krum distances is calculated.

Next, the number of malicious participants is estimated by finding the maximum gap between the distance list, e.g., distances in the sorted list. This is based on the assumption that most models 9 are benign and malicious models are different from the benign models (e.g., different from a threshold number or predefined number/percentage of benign models). So, there will be a sizable gap between the Krum distance list. If the maximum gap is much larger than the average, it could precisely separate malicious models from benign ones and decide the threshold for the Krum distance. If the Krum distance of the local model 9 is smaller than the threshold value, it will be marked as a malicious participant. On the other hand, if the maximum gap is close to the average gap, it may be assumed that the threshold cannot be accurately determined. To mitigate the attack risk, in one or more embodiments, only the local model 9 with the smallest Krum distance is marked as the benign participant.

Finally, in the last step, secure aggregation is performed by admitting only benign models into the global model aggregation. This prevents malicious data from influencing the global model 7 and the benign local models 9. Also, centralized control can be given to the malicious SBSs to ensure they can operate properly.

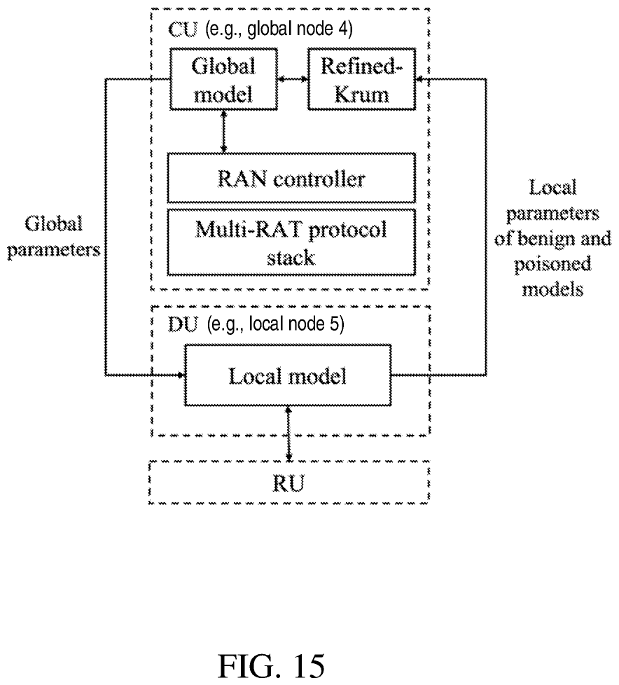

FIG. 15 is a block diagram of an example cloud implementation. In this implementation, the global node 4 of FL and the proposed defense algorithm are deployed at the control unit (CU). The local models 9 are deployed at distributed units (DUs). If there is an attack in the system, DUs will send local parameters of both benign models and poisoned models to the CU. The refined-Krum at CU will help the global node 4 perform a secure aggregation and the updated global parameters will be sent by to local models 9 at DUs.

Therefore, one or more embodiments may provide one or more of the following:
1. In the cell sleep control scenario, a Byzantine data poisoning attacks are provided by changing the rewards corresponding to specific actions. For the poisoned data, the model was configured or given an extra reward if the SBS chose to be active and an extra punishment if the SBS chose to sleep.
2. In the cell sleep control scenario, the trigger pattern of the backdoor attack is provided since the SBS has a very high traffic load over several transmission time intervals (e.g., over one or more predefined time period(s)/window(s)). It can be triggered by putting a piece of wireless device 22 with an extremely heavy traffic load into the system. The trigger result is defined as the SBS will turn to deep sleep (e.g., enter a deep sleep mode).
3. A defense model called refined-Krum is provided. The refined-Krum defense model includes four steps: calculating the similarity gaps, estimating the number of malicious participants, identifying malicious participants, and securing aggregation.

One or more embodiments provide one or more of the following advantages:
1. The attacks described herein were designed can degrade the network performance and lead to lower EE. Specifically, the backdoor attacks were designed to be stealthy and difficult to detect.
2. The defense algorithm we designed is more stable compared with some existing defense algorithms. In the wireless networks context, it can successfully prevent the system from some attacks and increase the system EE. It also has a high degree of applicability, and there are no specific requirements for FRL models.

### EXAMPLES

Example A1. A global node 4 configured to communicate with a plurality of local nodes 5, the global node 4 comprising:
receive a plurality of local models 9 from the plurality of local nodes 5, each local model 9 being associated with a respective one of the plurality of local nodes 5;
determine a plurality of Krum distances for the plurality of local models 9, each of the plurality of local models 9 being associated with a respective one of the plurality of Krum distances;
sort the plurality of local models 9 based on the plurality of Krum distances;
calculate a plurality of numerical gaps for the plurality of Krum distances, each one of the plurality of numerical gaps corresponding to a numerical gap between two Krum distances of two respective and adjacent local models of the sorted plurality of local models 9;
determine whether at least one of the plurality of local models 9 is at least one malicious participant based on the plurality of numerical gaps; and
train a global model 7 based on the determination.

Example A2. The global node 4 of Example A1, wherein the training of the global model 7 comprises:
excluding the at least one of the plurality of local models 9 that has been determined to be a malicious participant from training of the global model 7; and
training the global model 7 using a subset of the plurality of local models 9 that have not been determined to be at least one malicious participant.

Example A3. The global node 4 of any one of Examples A1-A2, wherein the processing circuitry 68 is further configured to:
indicate at least one updated parameter of the global model 7 to the plurality of local models 9 for training the respective local models 9.

Example A4. The global node 4 of any one of Examples A1-A3, wherein the at least one of the plurality of local models 9 that has been determined to be at least one malicious participant is associated with at least one of a Byzantine data poisoning attack and backdoor attack.

Example A5. The global node 4 of any one of Examples A1-A4, wherein the global model 7 is a federated learning model.

Example B1. A method implemented in a global node 4 that is configured to communicate with a plurality of local nodes 5, the method comprising:
receiving a plurality of local models 9 from the plurality of local nodes 5, each local model 9 being associated with a respective one of the plurality of local nodes 5;
determining a plurality of Krum distances for the plurality of local models 9, each of the plurality of local models 9 being associated with a respective one of the plurality of Krum distances;
sorting the plurality of local models 9 based on the plurality of Krum distances;
calculating a plurality of numerical gaps for the plurality of Krum distances, each one of the plurality of numerical gaps corresponding to a numerical gap between two Krum distances of two respective and adjacent local models 9 of the sorted plurality of local models 9;
determining whether at least one of the plurality of local models 9 is at least one malicious participant based on the plurality of numerical gaps; and
training a global model 7 based on the determination.

Example B2. The method of Example B1, wherein the training of the global model 7 comprises:
excluding the at least one of the plurality of local models 9 that has been determined to be a malicious participant from training of the global model 7; and
training the global model 7 using a subset of the plurality of local models 9 that have not been determined to be at least one malicious participant.

Example B3. The method of any one of Examples B1-B2, further comprising:
indicating at least one updated parameter of the global model 7 to the plurality of local models 9 for training the respective local models 9.

Example B4. The method of any one of Examples B1-B3, wherein the at least one of the plurality of local models 9 that has been determined to be at least one malicious participant is associated with at least one of a Byzantine data poisoning attack and backdoor attack.

Example B5. The method of any one of Examples B1-B4, wherein the global model 7 is a federated learning model.

Example C1. A local node 5 configured to communicate with a global node 4, the local node 5 configured to, and/or comprising a radio interface 62 and/or processing circuitry 68 configured to:
train a first local model 9;
communicate the first local model 9 to the global model 7;
receive at least one updated parameter, the updated parameter being based on:
   a plurality of Krum distances for a plurality of local models 9 including the first local model 9, each of the plurality of local models 9 being associated with a respective one of the plurality of Krum distances;
   a plurality of numerical gaps for the plurality of Krum distances, each one of the plurality of numerical gaps corresponding to a numerical gap between two Krum distances of two respective and adjacent local models 9 of the plurality of local models 9 that has been sorted according to the plurality of Krum distances; and
   whether at least one of the plurality of local models 9 is at least one malicious participant based on the plurality of numerical gaps; and
update the local model 9 using the updated parameter.

Example C2. The local node 5 of Example C1, wherein the processing circuitry 68 is further configured to train the updated local model 9.

Example D1. A method implemented in a local node 5 that is configured to communicate with a global node 4, the method comprising:
training a first local model 9;
communicating the first local model 9 to the global model 7;
receiving at least one updated parameter, the updated parameter being based on:
   a plurality of Krum distances for a plurality of local models 9 including the first local model 9, each of the plurality of local models 9 being associated with a respective one of the plurality of Krum distances;
   a plurality of numerical gaps for the plurality of Krum distances, each one of the plurality of numerical gaps corresponding to a numerical gap between two Krum distances of two respective and adjacent local models 9 of the plurality of local models 9 that has been sorted according to the plurality of Krum distances; and
   whether at least one of the plurality of local models 9 is at least one malicious participant based on the plurality of numerical gaps; and updating the local model 9 using the updated parameter.

Example D2. The method of Example D1, further comprising training the updated local model 9.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanation |
|---|---|
| CU | Control unit |
| DQN | Deep Q-networks |
| DRL | Deep reinforcement learning |
| DU | Distributed unit |
| FL | Federated learning |
| FRL | Federated reinforcement learning |
| MBS | Macro base station |
| ML | Machine learning |
| RAN | Radio access network |
| SBS | Small base station |
| UE | User equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a global node that is configured to communicate with a plurality of local nodes, each of the plurality of local nodes comprising a local model of a plurality of local models, the local model of the plurality of local models being associated with a plurality of local model parameters, the method comprising:
receiving the plurality of local model parameters from each of the plurality of local nodes;
determining a plurality of Krum distances for the plurality of local models, each of the plurality of local models being associated with a respective one of the plurality of Krum distances;
sorting the plurality of local models based on the plurality of Krum distances;
calculating a plurality of numerical gaps for the plurality of Krum distances, each one of the plurality of numerical gaps corresponding to a numerical gap between two Krum distances of two adjacent local models of the sorted plurality of local models;
determining whether to tag at least one of the plurality of local models as a malicious participant based on the plurality of numerical gaps; and
aggregating a global model to generate updated global model parameters, the aggregation of the global model being based on the determination.

2. The method of claim 1, further comprising excluding, from the aggregating, at least one of the plurality of local models that has been determined to be a malicious participant.

3. The method of claim 1, wherein the aggregating of the global model comprises aggregating a subset of the plurality of local models that are determined to be a non-malicious participant.

4. The method of claim 1, further comprising indicating the updated global model parameters to the plurality of local models for training.

5. The method of claim 1, wherein a local model tagged as a malicious participant is configured to reduce an accuracy of the global model if aggregated into the global model.

6. The method of claim 1, further comprising:
determining an average numerical gap of the plurality of numerical gaps;
if a maximum gap of the plurality of numerical gaps is less than a first threshold, tagging only a local model of the plurality of local models with a smallest Krum distance as a non-malicious participant;
the first threshold corresponding to a multiple of the average numerical gap; and
the aggregating of the global model being based on the local model tagged as the non-malicious participant.

7. The method of claim 1, further comprising:
determining an average numerical gap of the plurality of numerical gaps;
if a maximum gap of the plurality of numerical gaps is greater than a first threshold:
determining a second threshold to identify a malicious participant; and
for each local model of the plurality of local models having a Krum distance less than the second threshold, tagging the local model as a non-malicious participant;
the first threshold corresponding to a multiple of the average numerical gap; and
the aggregating of the global model being based on each local model that is tagged as a non-malicious participant.

8. The method of claim 1, wherein the aggregating of the global model is based on at least one local model of the plurality of local models that is not tagged as a malicious participant.

9. (canceled)

10. The method of claim 1, wherein the global node is a macro network node and the plurality of local nodes are a plurality of micro network nodes.

11. A global node configured to communicate with a plurality of local nodes, each of the plurality of local nodes comprising a local model of a plurality of local models, the local model of the plurality of local models being associated with a plurality of local model parameters, the global node configured to:
receive the plurality of local model parameters from each of the plurality of local nodes
determine a plurality of Krum distances for the plurality of local models, each of the plurality of local models being associated with a respective one of the plurality of Krum distances;
sort the plurality of local models based on the plurality of Krum distances;
calculate a plurality of numerical gaps for the plurality of Krum distances, each one of the plurality of numerical gaps corresponding to a numerical gap between two Krum distances of two adjacent local models of the sorted plurality of local models;
determine whether to tag at least one of the plurality of local models as a malicious participant based on the plurality of numerical gaps; and
aggregate a global model to generate updated global model parameters, the aggregation of the global model being based on the determination.

12.-20. (canceled)

21. A method implemented by a local node that is configured to communicate with a global node, the method comprising:
training a first local model, the first local model comprising local model parameters;
communicating the local model parameters to the global node;
receiving updated global model parameters associated with a global model, the updated global model parameters being based on:
a plurality of Krum distances for a plurality of local models including the first local model, each of the plurality of local models being associated with a respective one of the plurality of Krum distances;
a plurality of numerical gaps for the plurality of Krum distances, each one of the plurality of numerical gaps corresponding to a numerical gap between two Krum distances of two adjacent local models of the plurality of local models that have been sorted according to the plurality of Krum distances; and
whether any of the plurality of local models is a malicious participant based on the plurality of numerical gaps; and
an aggregation of a global model based on at least one of the plurality of local models that has been tagged as a non-malicious participant; and
updating the local model using the updated global model parameters.

22. The method of claim 21, wherein a malicious participant is configured to reduce an accuracy of the global model if aggregated into the global model.

23. The method of claim 21, wherein the updating of the local model using the updated global model parameters as part of a federated learning process.

24. The method of claim 21, wherein the local node is a micro network node and the global node is a macro network node.

25. A local node configured to communicate with a global node, the local node configured to:
train a first local model, the first local model comprising local model parameters;
communicate the local model parameters to the global node;
receive updated global model parameters associated with a global model, the updated global model parameters being based on:
a plurality of Krum distances for a plurality of local models including the first local model, each of the plurality of local models being associated with a respective one of the plurality of Krum distances;
a plurality of numerical gaps for the plurality of Krum distances, each one of the plurality of numerical gaps corresponding to a numerical gap between two Krum distances of two adjacent local models of the plurality of local models that have been sorted according to the plurality of Krum distances;
whether any of the plurality of local models is a malicious participant based on the plurality of numerical gaps; and
an aggregation of a global model based on at least one of the plurality of local models that has been tagged as a non-malicious participant; and
update the local model using the updated global model parameters.

26.-28. (canceled)
